(19) United States
(12) Patent Application Publication
(10) Pub. No.: US 2025/0094824 A1
(43) Pub. Date: Mar. 20, 2025

(54) FEDERATED LEARNING WITH NEURAL GRAPHICAL MODELS

(71) Applicant: Microsoft Technology Licensing, LLC, Redmond, WA (US)

(72) Inventors: Harsh SHRIVASTAVA, Redmond, WA (US); Urszula Stefania CHAJEWSKA, Issaquah, WA (US)

(21) Appl. No.: 18/370,227

(22) Filed: Sep. 19, 2023

(51) Int. Cl. G06N 3/098; G06N 3/047

(52) U.S. Cl. CPC G06N 3/098; G06N 3/047

(57) ABSTRACT

The present disclosure relates to methods and systems that provide a federated learning framework using Neural Graphical Models. The federated learning framework combines the individual distributions learned by each client into a global model while keeping the data of each client private within each client's environment. The methods and systems allow for knowledge sharing among the clients without data sharing.

### BACKGROUND

Federated Learning (FL) addresses the need to create models based on proprietary data in such a way that multiple clients retain exclusive control over their data, while all clients benefit from improved model accuracy due to pooled resources. A lot of data remains proprietary and hidden behind a firewall, especially in domains with privacy concerns (e.g., medicine). Federated learning is a framework for model development that is partially or fully distributed over many clients ensuring data privacy. Current federated learning frameworks are generally developed for prediction models for a single preselected outcome variable.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes receiving, from a plurality of clients, a plurality of feature dependency graphs, wherein each client provides a feature dependency graph created using data of each client. The method includes generating, using a merge function, a global dependency graph from the plurality of feature dependency graphs, wherein nodes in the global dependency graph contain an intersection of features of the plurality of feature dependency graphs. The method includes providing, to the plurality of clients, the global dependency graph.

Some implementations relate to a device. The device includes a processor; memory in electronic communication with the processor; and instructions stored in the memory, the instructions being executable by the processor to: receive, from a plurality of clients, a plurality of feature dependency graphs, wherein each client provides a feature dependency graph created using data of each client; generate, using a merge function, a global dependency graph from the plurality of feature dependency graphs, wherein nodes in the global dependency graph contain an intersection of features of the plurality of feature dependency graphs; and provide, to the plurality of clients, the global dependency graph.

Some implementations relate to a method. The method includes receiving, from a plurality of clients, a plurality of Neural Graphical Models, wherein each Neural Graphical Model is trained locally by a client using a global dependency graph and data of the client. The method includes training a global Neural Graphical Model using the plurality of Neural Graphical Models and the global dependency graph, wherein the global Neural Graphical Model represents an aggregate distribution over a domain of the data used to train each Neural Graphical Model. The method includes providing, to the plurality of clients, the global Neural Graphical Model.

Some implementations relate to a device. The device includes a processor; memory in electronic communication with the processor; and instructions stored in the memory, the instructions being executable by the processor to: receive, from a plurality of clients, a plurality of Neural Graphical Models, wherein each Neural Graphical Model is trained locally by a client using a global dependency graph and data of the client; train a global Neural Graphical Model using the plurality of Neural Graphical Models and the global dependency graph, wherein the global Neural Graphical Model represents an aggregate distribution over a domain of the data used to train each Neural Graphical Model; and provide, to the plurality of clients, the global Neural Graphical Model.

Some implementations relate to a method. The method includes generating, using a merge function, a global dependency graph from a plurality of feature dependency graphs received from a plurality of clients, wherein nodes in the global dependency graph contain an intersection of features of the plurality of feature dependency graphs. The method includes providing, to the plurality of clients, the global dependency graph. The method includes receiving, from the plurality of clients, a plurality of Neural Graphical Models trained locally by a client using data from the client and the global dependency graph. The method includes training a global Neural Graphical Model using the plurality of Neural Graphical Models and the global dependency graph, wherein the global Neural Graphical Model represents an aggregate distribution over a domain of the data used to train each Neural Graphical Model. The method includes providing, to the plurality of clients, the global Neural Graphical Model.

Some implementations relate to a device. The device includes a processor; memory in electronic communication with the processor; and instructions stored in the memory, the instructions being executable by the processor to: generate, using a merge function, a global dependency graph from a plurality of feature dependency graphs received from a plurality of clients, wherein nodes in the global dependency graph contain an intersection of features of the plurality of feature dependency graphs; provide, to the plurality of clients, the global dependency graph; receive, from the plurality of clients, a plurality of Neural Graphical Models trained locally by a client using data from the client and the global dependency graph; train a global Neural Graphical Model using the plurality of Neural Graphical Models and the global dependency graph, wherein the global Neural Graphical Model represents an aggregate distribution over a domain of the data used to train each Neural Graphical Model; and provide, to the plurality of clients, the global Neural Graphical Model.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for obtaining a global dependency graph for use in a federated learning framework in accordance with implementations of the present disclosure.

FIG. 2 illustrates an example environment for obtaining a global Neural Graphical Model for use in a federated learning framework in accordance with implementations of the present disclosure.

FIG. 3 illustrates an example of an algorithm in accordance with implementations of the present disclosure.

FIG. 4 illustrates an example method for generating a global dependency graph for use in a federated learning framework in accordance with implementations of the present disclosure.

FIG. 5 illustrates an example method for generating a global Neural Graphical Model for use in a federated learning framework in accordance with implementations of the present disclosure.

FIG. 6 illustrates components that may be included within a computer system.

### DETAILED DESCRIPTION

This disclosure generally relates to federated learning. Federated learning is a framework for model development that is partially or fully distributed over many clients ensuring data privacy. Many of the current federated learning frameworks are developed for prediction models for a single preselected outcome variable.

There are two primary network architectures used for federated learning, the centralized paradigm and the decentralized paradigm. The centralized paradigm is where one global model is maintained, and the local models are updated periodically. An example of a Centralized federated learning frameworks may use a federated matched averaging algorithm (or its variants) which does neuron matching to tackle the permutation invariance in the neural network based architectures. Dummy neurons are introduced while optimizing using the Hungarian matching algorithm, causing the global model size to blow up considerably (e.g., the number of model parameters increases significantly as clients are added to the centralized federated learning framework). In addition, current federated learning frameworks are usually developed with keeping specific deep learning architectures in mind. For instance, it is not straightforward to handle skip connections in current federated learning systems due to the dynamic resizing of neural network layers. The decentralized paradigm performs decoupled learning in a peer-to-peer communication system.

The methods and systems of the present disclosure provide a federated learning framework using Neural Graphical Models, a type of probabilistic graphical models. The present disclosure includes a number of practical applications that provide benefits and/or solve problems associated with federated learning using probabilistic graphical models. Examples of these applications and benefits are discussed in further detail below.

Neural Graphical Models are probabilistic graphical models that utilize the expressive power of neural networks to learn complex non-linear dependencies between the input features. Neural Graphical Models learn to capture the underlying data distribution and have efficient algorithms for inference and sampling.

Neural Graphical Models are a type of probabilistic graphical model that handle complex distributions over a domain and represents a richer set of distributions as compared to traditional probabilistic graphical models. Neural Graphical Models remove the restrictions previously placed over a domain by traditional probabilistic graphical models. Neural Graphical Models represent complex distributions without restrictions on the domains or predefined assumptions about the domains and may capture any type of distribution defined by the data for a domain.

Neural Graphical Models accept a feature dependency structure that can be given by an expert or learned from data. The dependency structure may have the form of a graph with clearly defined semantics (e.g., a Bayesian network graph or a Markov network graph) or an adjacency matrix. The graph may be either directed or undirected. Based on this dependency structure, Neural Graphical Models represent the probability function over the domain using a deep neural network. The parameterization of such a network can be learned from data efficiently, with a loss function that jointly optimizes adherence to the given dependency structure and fit to the data. Probability functions represented by Neural Graphical Models are unrestricted by any of the common restrictions inherent in other probabilistic graphical models.

In some implementations, the Neural Graphical Models are presented in a neural view with a neural network. The neural view of the Neural Graphical Models represents the functions of the different features using a neural network. The neural network represents the distribution(s) over the domain. In some implementations, the neural network is a deep learning architecture with hidden layers. The functions represented using the neural view capture the dependencies identified in the dependency structure. The functions are represented in the neural view by the paths from nodes in the input layer through the neural network hidden layer(s) to the node in the output layer. Thus, as the number of neural network layers increases in the neural view and/or the number of units in each hidden layer increase, the complexity of the functions represented by the neural view increases. The neural view of the Neural Graphical Models represent complex distributions over features of a domain.

Learning, inference, and sampling are operations that make Neural Graphical Models useful for domain exploration. Learning, in a broad sense, consists of fitting the distribution function parameters from data. Inference is the procedure of answering queries in the form of marginal distributions or reporting conditional distributions with one or more observed variables. Sampling is the ability to draw samples from the distribution defined by the Neural Graphical Model.

Neural Graphical Models learn the underlying distribution from multimodal data. Moreover, Neural Graphical Models inference capabilities allow efficient calculation of conditional and marginal probabilities which can answer many complex queries.

The methods and systems provide a federated learning framework using Neural Graphical Models that maintain a global model that learns the averaged information from local models from a plurality of clients while keeping the training data within the client's environment. Neural Graphical Models are more flexible than predictive models, as they learn a distribution over all features in a domain and can answer queries about any variable's probability conditional on an assignment of value to any other feature or set of features. Extending the Neural Graphical Model framework to handle multiple private datasets allows for knowledge sharing without data sharing, a critical goal in sensitive domains, such as healthcare. The methods and systems can train a global master model, capturing all domain knowledge from the clients and individual clients can train personalized models on their data and analyze difference between their local model and the global model to get valuable insights.

The global model size is the same order of magnitude in terms of the number of parameters as the clients' models in the methods and systems of the present disclosure. In the cases where clients have local variables that are not part of the combined global distribution, an algorithm may be used which personalizes the global models to the clients by merging the additional variables using the client's data.

One technical advantage of the systems and methods of the present disclosure is the number of parameters in the global model remains comparable to the clients' models. As the number of clients increase or are added to the federated learning framework, the size of the global model does not explode in size (model parameter explosion), but instead, remains within the same order of magnitude with the addition of clients. Another technical advantage of the systems and methods of the present disclosure is allowing querying over multiple variables. Having federated learning for probabilistic graphical models, allows for more flexibility of use as compared to predictive models for a single preselected outcome variable. Another technical advantage of the systems and methods of the present disclosure is the federated Neural Graphical Models can model a domain with mixed data types: not just continuous and categorical, but also text, image, etc. Another technical advantage of the systems and methods of the present disclosure is compatibility with various network communication architectures. Another technical advantage of the systems and methods of the present disclosure is maintaining data privacy. The Neural Graphical Models of the systems and methods of the present disclosure are robust to data heterogeneity, large number of participants, and limited communication bandwidth.

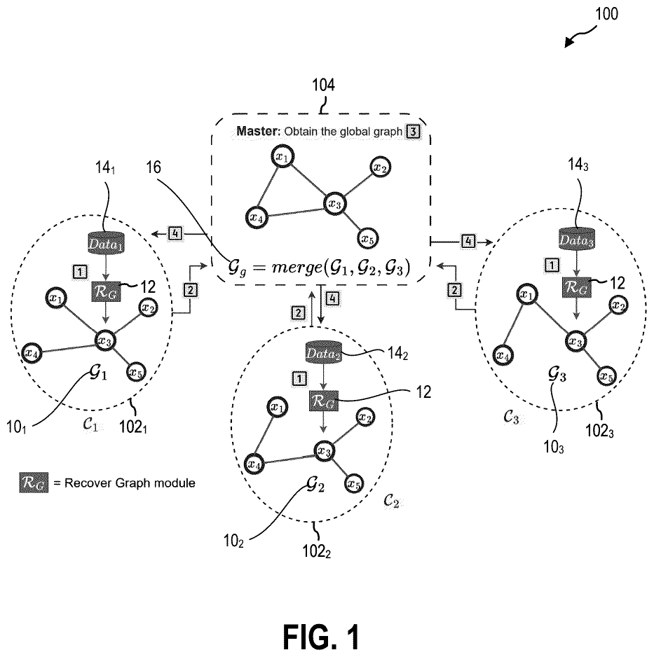

Referring now to FIG. 1, illustrated is an example environment 100 for obtaining a global consensus graph to use in a federated learning framework with Neural Graphical Models. A Neural Graphical Model is a type of probabilistic graphical model implemented using a deep neural network that handles complex distributions over a domain. A domain is a complex system that is being modeled (e.g., a disease process or a school admission process). The Neural Graphical Model represents complex distributions over the domain without restrictions on the domain or predefined assumptions of the domain. The Neural Graphical Model has the ability to model with multimodal input data types and may capture any type of data for the domain.

The environment 100 includes a plurality of clients 102 (e.g., client 1 (C₁) 102₁, client 2 (C₂) 102₂, client 3 (C₃) 102₃ up to n, where n is a positive integer) in communication with a master 104. The clients 102 are computing devices. The master 104 is a computing device in communication with the computing devices of the clients 102. In some implementations, the master 104 is a server (e.g., a cloud server) remote from the computing devices of the clients 102 and the master 104 is accessed by the clients 102 via a network. In some implementations, the clients 102 are devices in the cloud. The network may include the Internet or other data link that enables transport of electronic data between respective devices and/or components of the environment 100.

At 1, each client 102 (e.g., client 1 (C₁) 102₁, client 2 (C₂) 102₂, client 3 (C₃) 102₃) generates a feature dependency graph 10 using a recover graph module 12 on data 14 from the client 102. For example, client 1 (C₁) 102₁ generates a feature dependency graph 10₁ using a recover graph module 12 on the data 141 of the client 1 (C₁) 102₁. Client 2 (C₂) 102₂ generates a feature dependency graph 10₂ using a recover graph module 12 on the data 14₂ of the client 2 (C₂) 102₂. Client 3 (C₃) 102₃ generates a feature dependency graph 10₃ using a recover graph module 12 on the data 14₃ of the client 3 (C₃) 102₃. In some implementations, the data 14 is multimodal data that spans different types of data (e.g., text, images, continuous, categorical, etc.) and contexts of data.

In some implementations, the data 14 is private to each client 102. For example, each client 102 has private datasets (e.g., the data 14) that cover the same domain {X1, X2, . . . , XC}, where each dataset Xc consists of Mc samples, with each sample assigning values to the feature set Fc for the client. The datasets share some, potentially not all, features. That is, each dataset Xc contains a subset of all features in the domain Fc c F. Moreover, for some features, value sets overlap and for others they may be completely disjoint.

Each client 102 generates a feature dependency graph 10 with a dependency structure based on the data 14 of the client 102 using a recover graph module 12. The feature dependency graphs 10 may differ in their feature sets. In addition, the recover graph module 12 used by each client 102 may differ. Examples of a recover graph module 12 include undirected graph recovery methods (e.g., Markov network recovery methods, graphical lasso based methods such as uGLAD algorithm, or regression-based methods such as Neural Graph Revealers), directed graph recovery methods (score based or constraint based for Bayesian networks). Each client 102 uses the recover graph module 12 to generate the feature dependency graph 10 and determines the graph structure for the feature dependency graph 10 based on the data 14. The feature dependency graph 10 supports generic graph structures, including directed graphs, undirected graphs, and/or mixed-edge graphs.

The dependency structure identifies which features in the data 14 are directly dependent on each other and which pairs of features in the data 14 exhibit conditional independencies given other features. In some implementations, the feature dependency graph 10 includes a dependency structure with an adjacency matrix. In some implementations, the dependency structure is illustrated as edges in the feature dependency graph 10.

At 2, each client 102 shares the feature dependency graph 10 generated by the client 102 with the master 104. The clients 102 share the dependency structure of the feature dependency graph 10 with the master 104 without sharing the data 14 used to create the feature dependency graph 10, allowing the client datasets (e.g., the data 14) to remain private to the client 102.

At 3, the master 104 uses a merge function to merge the feature dependency graphs 10 received from each client 102 into a global dependency graph 16. In some implementations, the merge function considers the common features across the clients 102 F_{g}=∩_{c=1}^{C} F_{c} and a union of all the edges among these common features is used to obtain the global dependency graph 16. The nodes of the global dependency graph 16 contain an intersection of features from all clients.

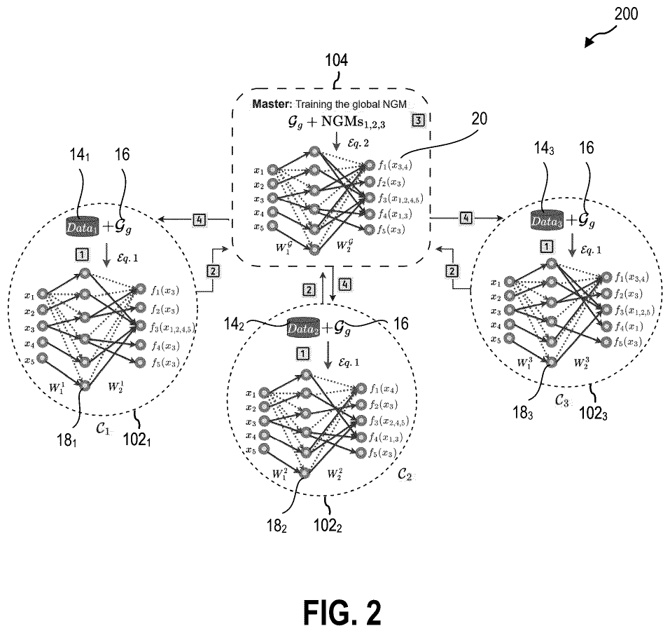

At 4, the master 104 sends the global dependency graph 16 to each client 102. Each client 102 trains a model using the global dependency graph 16 and the data 14 of the clients. The training by each client 102 using the global dependency graph 16 and the data 14 is discussed more in detail below in FIG. 2.

Each client 102 shares the trained model with the master 104. Each client 102 shares the model parameters (not the data 14) and the size of the dataset to the master 104 with the Neural Graphical Model 18, allowing the data 14 to remain private within the client's 102 environment.

In some implementations, one or more computing devices (e.g., servers and/or devices) are used to perform the processing of the environment 100. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, each client 102 is implemented wholly on a computing device. Another example includes the master 104 implemented wholly on a computing device. Another example includes one or more subcomponents of each client 102 and the master 104 implemented across multiple computing devices. Moreover, in some implementations, one or more subcomponent of the clients 102 and/or the master 104 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

Referring now to FIG. 2, illustrated is an example environment 200 for obtaining a global Neural Graphical Model 20 for use in a federated learning framework using the clients 102 and the master 104 from the environment 100 in FIG. 1.

At 1, each client 102 (e.g., client 1 (C₁) 102₁, client 2 (C₂) 102₂, client 3 (C₃) 102₃) generates a Neural Graphical Model 18 using the data 14 of the client 102 and the global dependency graph 16. For example, client 1 (C₁) 102₁ trains a Neural Graphical Model 181 using the data 141 of the client 1 (C₁) 102₁ and the global dependency graph 16. Client 2 (C₂) 102₂ trains a Neural Graphical Model 18₂ using the data 14₂ of the client 2 (C₂) 102₂ and the global dependency graph 16. Client 3 (C₃) 102₃ trains a Neural Graphical Model 18₃ using the data 14₃ of the client 3 (C₃) 102₃ and the global dependency graph 16. In some implementations, the Neural Graphical Models 18 generated by each client 102 have the same dimensions in terms of the number of hidden units, number of layers, and the non-linearity used.

Neural Graphical Models 18 represents the functions of the different features using a neural network. The neural network represents the distribution(s) of the data 14 over the domain. In some implementations, the neural network is a deep learning architecture with hidden layers. The functions represented using the neural view capture the dependencies identified in the dependency structure of the global dependency graph 16. The functions are represented in the neural view by the paths from nodes in the input layer through the neural network hidden layer(s) to the node in the output layer. Thus, as the number of neural network layers increases in the neural view and/or the number of units in each hidden layer increase, the complexity of the functions represented by the neural view increases. The Neural Graphical Models 18 represent complex distributions over features of a domain.

In some implementations, each client 102 trains the Neural Graphical Models 18 using a local model optimization of the data 14 and the global dependency graph 16. For each client 102, given its local data 14 (Xc), the goal of the local model optimization is to find the set of parameters W that minimize the loss expressed as the average distance from individual sample k, X_{c}^{k} to the model output given that sample f_{w}(X_{c}^{k}) while maintaining the dependency structure provided in the global dependency graph 16.

An example equation specifying the loss used by each client 102 to train a Neural Graphical Model 18 is illustrated in Equation (1) below:

$${arg min}_{𝒲} \text{?} ‖ \text{?} - \text{?} λ log ( ‖ ( \text{?} ) \text{?} ) \qquad ( 1 )$$

$$\text{?} \text{indicates text missing or illegible when filed}$$

where S‘ represents the complement of the master-provided adjacency matrix S, which replaces 0 by 1 and vice-versa. The A*B is the Hadamard operation. The Neural Graphical Models may differ in their values sets among each client 102. Each client 102 trains the Neural Graphical Model 18 that only contains the common features of the data 14 among the clients 102.

At 2, each client 102 sends the Neural Graphical Model 18 to the master 104. The Neural Graphical Models 18 are trained locally at each client 102 using the data 14 of each client 102. Each client 102 shares the Neural Graphical Model 18 with the master 104. Each client 102 shares the model parameters (not the data 14) and the size of the dataset with the master 104, allowing the data 14 to remain private to the client 102. The master 104 receives the Neural Graphical Models 18 without any access to the clients' 102 data 14.

At 3, the master 104 trains a global Neural Graphical Model 20 using the Neural Graphical Models 18 received from each client 102 and the global dependency graph 16. In training to the global Neural Graphical Model 20, the master 104 distills knowledge from the Neural Graphical Models 18 received from each client 102 (the trained local Neural Graphical Models received from each client 102) without using any data samples from the data 14 of the various clients 102.

The master 104 trains the global Neural Graphical Model 20 to learn the average of the Neural Graphical Models 18 (the trained local Neural Graphical Models received from each client 102) using the global dependency graph 16. Each client 102 learns a distribution over the same independent structure (the global dependency graph 16) and the task of the global Neural Graphical Model 20 is to learn an average of the distributions represented by the local Neural Graphical Models 18. An example equation that the master 104 uses in training the global Neural Graphical Model 20 is illustrated below in Equation (2):

$$\text{?} ‖ \text{?} - \frac{1}{C} \text{?} log ( ‖ ( \text{?} ) \text{?} ) \qquad ( 2 )$$

$$\text{?} \text{indicates text missing or illegible when filed}$$

where γ is the Lagrangian penalty constant. The first term adjusts the distribution represented by the global model to be close to the (weighted) average of the client models. The second term ensures that the NGM's dependency structure is as close as possible to the global graph G. The penalty constant allows for a precise trade-off between these two optimization goals. Equation (2) allows the master 104 to keep a size of the Neural Graphical Model 20 within the same order of magnitude in terms of the number of parameters as the master 104 learns the average of the local Neural Graphical Models 18. As local Neural Graphical Models 18 are added, equation (2) allows the master 104 to keep a size of the Neural Graphical Model 20 from increasing and preventing the model parameter explosion that occurs in some current federated learning solutions. In some implementations, a size of the Neural Graphical Model 20 is a maximum size of the Neural Graphical Models 18 provided by the clients 102.

In some implementations, the master 104 performs additional training on the global Neural Graphical Model 20 to obtain desired results. For example, the master 104 uses any additional public data and samples X_{G} from the Neural Graphical Models 18 as an additional regression term in the objective (represented by L_{G}(W)). An example equation that the master 104 uses for additional training using public datasets is illustrated below in Equation (3).

$${arg min}_{𝒲} {ℒ}_{𝒢} ( 𝒲 ) + {\sum }_{k = 1}^{{M}_{𝒢}} {‖ {X}_{𝒢}^{k} - {f}_{𝒲} ( {X}_{𝒢}^{k} ) ‖}_{2}^{2} \qquad ( 3 )$$

In some implementations, the additional regression term is used to address issues, such as, handling distribution shifts in the clients' 102 data 14 or doing weighted averaging over the Neural Graphical Models 18. The master 104 leverages the sampling ability of the Neural Graphical Models 18 provided by the clients 102 and generates the regression data X for the global Neural Graphical Model 20. The master 104 may balance the data generated by controlling the amount of samples from the Neural Graphical Models 18, and thus, controlling the bias while fitting the global Neural Graphical Model 20.

At 4, the master 104 provides the global Neural Graphical Model 20 to the clients 102. The global Neural Graphical Model 20 covers the common feature sets and the union of value sets across the different clients 102. The global Neural Graphical Model 20 allows the clients 102 to benefit from the diverse datasets from the clients 102 while keeping the data 14 private to the clients' 102. The global Neural Graphical Model 20 pools the data 14 (e.g., the data 141 of the client 1 (C₁) 102₁, the data 14₂ of the client 2 (C₂) 102₂, the data 143 of the client 3 (C₃) 102₃) and learns the underlying data distribution from the data 14 while keeping the data 14 within the client's 102 environment. In some implementations, the master 104 ensures that the global Neural Graphical Model 20 is based on no less than k (where k is a positive integer) clients' 102 data 14. The value for k may be determined based on the sensitivity of the data 14. For example, k may be a higher number for sensitive data that must remain private (e.g., sensitive patient information).

Each client 102 runs the global Neural Graphical Model 20 with the local data 14 of the client 102. In some implementations, the clients 102 use the global Neural Graphical Model 20 to perform inference and sampling for downstream tasks. For example, applications on the client 102 perform one or more tasks on the global Neural Graphical Model 20. One example task includes prediction using the global Neural Graphical Model 20. Another example task includes an inference task using the global Neural Graphical Model 20. Inference is the process of using the global Neural Graphical Model 20 to answer queries. For example, a user provides a query to the application and the application use the global Neural Graphical Model 20 to perform the inference task on the global Neural Graphical Model 20 and output an answer to the query. The query may include observed or hypothetical evidence (assignment of values) on a subset of variables. In such cases, the answer to the query will include conditional probability distribution over the remaining variables or maximum a posteriori (MAP) assignment of values to the remaining variables. The inference task may support any input data type using the global Neural Graphical Model 20.

The global Neural Graphical Model 20 allows the clients 102 to query over multiple variables. Moreover, since the global Neural Graphical Model 20 learns the probability distribution of the data 14 from each client 102 over the domain, the global Neural Graphical Model 20 may be used to perform inference and sampling over any variable without needing a separate predictive model for each variable.

One example use case of using the global Neural Graphical Model 20 for the analysis of clinical trials. Clinical trials explore the safety and efficacy of medical interventions: drugs, procedures, devices and treatments. Clinical trials are run as randomized controlled experiments with treatment group(s) and control group(s) with carefully screened participants. A detailed evaluation and comparison between groups (often including also subgroups) is performed at the end. Clinical trials proceed in three phases, moving to the next phase usually requires an FDA (or analogous agency) approval. There are publicly available databases of privately and publicly funded clinical studies conducted around the world. However, majority of clinical trials conducted are not reported to the publicly available databases. Large pharmaceutical companies which sponsor tens and hundreds of clinical trials may have trial data not yet reported or databases with more detailed trial data than officially available in the publicly available databases. Leveraging such data through federated learning with the privacy guarantees provided by the global Neural Graphical Model 20 would result in more accurate models for everyone to use in the inference and sampling tasks. One of the benefits of pooling all clinical trial data would be to obtain more accurate assessment of clinical trial success rates for each phase and provide insight into features with most impact on that success. The global Neural Graphical Model 20 may generate predictions of any variable of interest, including overall success of the trial, successful recruitment of volunteers, assess the probability of treatment being effective, etc. In addition, the global Neural Graphical Model 20 may also provide insight into dependencies between variables in the clinical trial, providing the clients 102 with more reasoning capabilities for the client trials.

In some implementations, each client 102 customizes the global Neural Graphical Model 20 by using the data 14 of the client 102 to personalize the global Neural Graphical Model 20 to each individual client 102. The data 14 of each client 102 may have different distributions and/or different feature sets. In some implementations, a client 102 runs an algorithm to incorporate client specific features from the data 14.

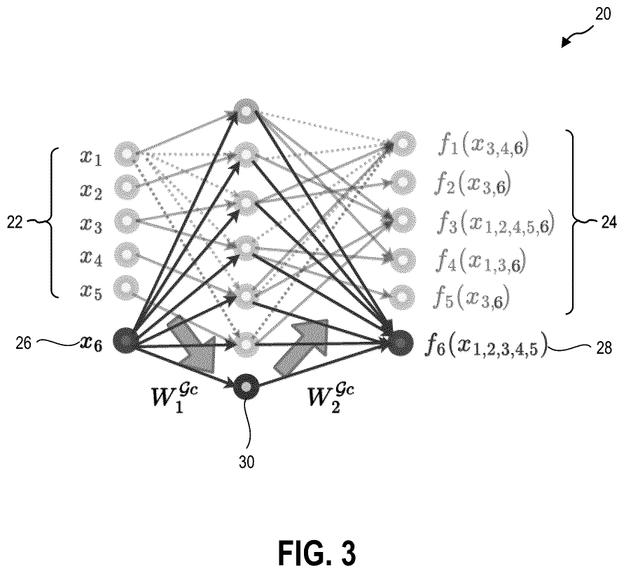

Referring now to FIG. 3, illustrated is an example of the algorithm for use with the global Neural Graphical Model 20 to add client specific features from the data 14. For example, the algorithm is performed by a client 102 (e.g., the client 102₂ using the data 14₂ of the client 102₂).

The nodes 22 (e.g., x₁, x₂, x₃, x₄, x₅) and the functions 24 (e.g., f₁, f₂, f₃, f₄, f₅) are in the global Neural Graphical Model 20. Each client 102 receives the same nodes 22 and functions 24 as well as model weights for connections between the input layer and the first hidden layer, between hidden layers and from the last hidden layer to the output layer in the global Neural Graphical Model 20 from the master 104. The node 26 is the client specific features from the data 14 of the client 102 added to the global Neural Graphical Model 20 to personalize the global Neural Graphical Model 20 for the client 102. There may be more than one client specific feature added.

The hidden unit 30 is added to the global Neural Graphical Model 20 to facilitate capturing of dependencies between the common features (e.g., the nodes 22) and the newly added features (e.g., the node 26). There may be more than one new hidden unit added to every hidden layer. The new edges (e.g., the lines from the node 26 through the all hidden units, including the hidden unit 30 and from hidden units to the output layer allow the model to capture dependencies between client specific features and common features represented in nodes 22) learned from the client's 102 data 14.

The client 102 initializes the weights of the personalized augmented global Neural Graphical Model 20 as Wᵢ^{g}^{_{c}}=Wᵢ^{g}∪W_{E}, where Wᵢ^{E} represent the weights for the new edges. The client 102 retrains the global Neural Graphical Model 20 using equation (1) (FIG. 2) by freezing the weights Wᵢ^{g}'s obtained by the global Neural Graphical Model 20. The dependency structure is slightly modified in s_{g}_{_{c}} the graph constraint to account for the additional variables.

The new output unit(s) is (are) added to the output layer representing the client-specific feature(s), matching the additions to the input layer. The function(s) 28 associated with the new output unit(s) represents the dependencies of the node 26 learned using the client's 102 data 14. While the illustrated example shows a dependency on all of the nodes 22 (e.g., x₁, x₂, x₃, x₄, x₅) in the personalized augmented global Neural Graphical Model 20, any number of dependencies may be learned using the client's 102 data 14 (e.g., the new node 26 depends on a subset of the nodes 22 (x₂, x₅)). In addition, the number of hidden units 30 may be increased during the personalization of the global Neural Graphical Model 20 for different desired results.

Another example includes each client 102 performing the algorithm with each client's 102 data 14. Each client 102 personalizes the global Neural Graphical Model 20 with different feature sets of each client's 102 data 14. Thus, the personalized Neural Graphical Models 20 may differ between each client 102 in response to the personalization performed by each client 102 using the client's 102 data 14.

Personalizing the global Neural Graphical Model 20 to the data 14 of each client 102 allows the federated learning framework discussed in FIGS. 1 and 2 to support clients 102 with overlapping feature sets in the data 14 while maintaining a size of the global Neural Graphical Model 20 shared with each client 102. Moreover, each client 102 can train a personalized Neural Graphical Model on the client's data 14 and analyze differences between the personalized model and the global Neural Graphical Model 20 to get valuable insights.

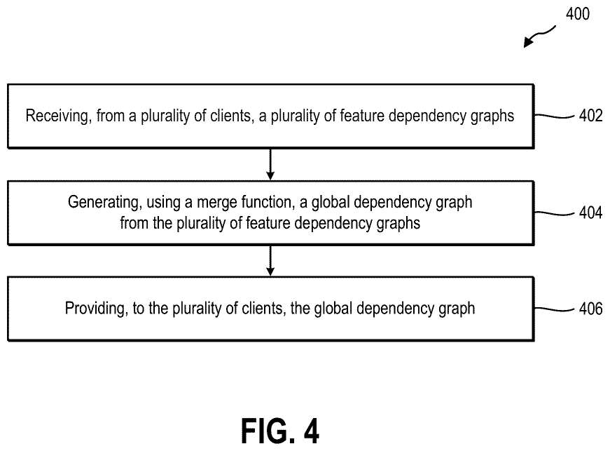

Referring now to FIG. 4, illustrated is an example method 400 for generating a global dependency graph 16 (FIGS. 1 and 2). The actions of the method 400 are discussed below with reference to FIGS. 1 and 2.

At 402, the method 400 includes receiving, from a plurality of clients, a plurality of feature dependency graphs. The master 104 receives from the clients 102 a plurality of feature dependency graphs 10. Each client 102 provides to the master 104 a feature dependency graph 10 created using the data 14 of each client 102. In some implementations, the data 14 is private data to the client 102 (e.g., company information, research results, personal identifiable information, patient information, etc.). The feature dependency graphs 10 of each client 102 may differ in their feature sets.

In some implementations, each client 102 uses a graph recovery algorithm on the data 14 of each client 102 to generate the feature dependency graph 10 with a dependency structure of the data 14. The dependency structure identifies which features in the data 14 are directly dependent on each other and which pairs of features in the data 14 exhibit conditional independencies given other features. For example, client 1 (C₁) 102₁ generates a feature dependency graph 10₁ using a recover graph module 12 on the data 141 of the client 1 (C₁) 102₁. Client 2 (C₂) 102₂ generates a feature dependency graph 10₂ using a recover graph module 12 on the data 14₂ of the client 2 (C₂) 102₂. Client 3 (C₃) 102₃ generates a feature dependency graph 10₃ using a recover graph module 12 on the data 14₃ of the client 3 (C₃) 102₃. In some implementations, the data 14 is multimodal data that spans different types of data (e.g., continuous, categorical, text, images, etc.) and contexts of data.

At 404, the method 400 includes generating, using a merge function, a global dependency graph from the plurality of feature dependency graphs. The master 104 uses a merge function to generate a global dependency graph 16 from the plurality of feature dependency graphs 10. The global dependency graph 16 captures a dependency structure of input features for a domain of the data 14 used by each client 102 to create the plurality of feature dependency graphs 10 without sharing the data 14 with the master 104 or with other clients 102. The dependency structure identifies which features in the data 14 are directly dependent on each other and which pairs of features in the data 14 exhibit conditional independencies given other features.

In some implementations, the merge function identifies common features of the plurality of feature dependency graphs 10 and provides a union of edges among the common features in the global dependency graph 16. The merge function maintains a size of the number of parameters of the global dependency graph 16 to be roughly of the same order of magnitude as the sizes of clients' graphs when combining the plurality of feature dependency graphs 10 into the global dependency graph 16.

At 406, the method 400 includes providing, to the plurality of clients, the global dependency graph. The master 104 provides to the clients 102 the global dependency graph 16. The nodes in the global dependency graph 16 contain an intersection of the features of the plurality of feature dependency graphs 10.

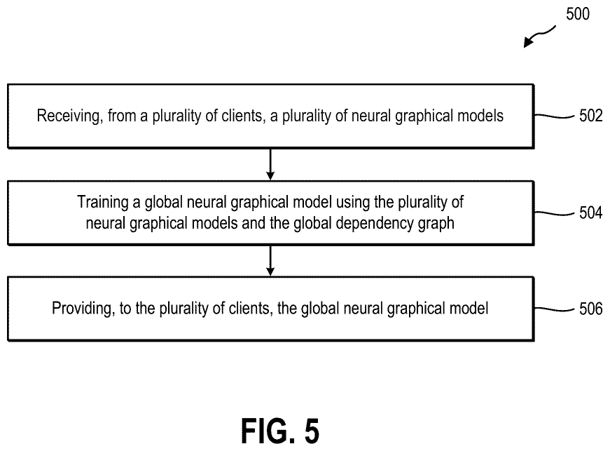

Referring now to FIG. 5, illustrated is an example method 500 for generating a global Neural Graphical Model 20 (FIGS. 1 and 2). The actions of the method 500 are discussed below with reference to FIGS. 1-3.

At 502, the method 500 includes receiving, from a plurality of clients, a plurality of Neural Graphical Models. The master 104 receives from the clients 102 a plurality of Neural Graphical Models 18. Each Neural Graphical Model 18 is trained locally by a client 102 using the global dependency graph 16 and the data 14 of the client 102. The global dependency graph 16 captures a dependency structure of input features for the domain of the data 14 used to create the dependency structure without sharing the data 14 with the master 104 or with other clients 102.

For example, client 1 (C₁) 102₁ trains a Neural Graphical Model 181 using the data 141 of the client 1 (C₁) 102₁ and the global dependency graph 16. Client 2 (C₂) 102₂ trains a Neural Graphical Model 18₂ using the data 14₂ of the client 2 (C₂) 102₂ and the global dependency graph 16. Client 3 (C₃) 102₃ trains a Neural Graphical Model 18₃ using the data 14₃ of the client 3 (C₃) 102₃ and the global dependency graph 16. In some implementations, the Neural Graphical Models 18 generated by each client 102 have the same dimensions in terms of the number of hidden units, number of layers, and the non-linearity used.

Each client 102 sends model parameters and the size of the dataset with the Neural Graphical Model 18 to the master 104 without sharing the data 14 used to train the Neural Graphical Model 18 with the master 104 or other clients 102. The master 104 receives the Neural Graphical Models 18 from the clients 102 without access to the clients' 102 data 14.

At 504, the method 500 includes training a global Neural Graphical Model using the plurality of Neural Graphical Models and the global dependency graph. The master 104 trains a global Neural Graphical Model 20 using the plurality of Neural Graphical Models 18 and the global dependency graph 16. In some implementations, the master 104 learns an average of the distribution over input features common to all clients for the domain of the data 14. For example, during the training, the master 104 adjusts the distribution to a weighted average of the plurality of Neural Graphical Models 18 and adjusts a dependency structure of the global Neural Graphical Model 20 to the dependency structure of the global dependency graph 16. In some implementations, during the training, the master 104 leverages publicly available data. The global Neural Graphical Model 20 represents an aggregate distribution over a domain of the data 14 used to train each Neural Graphical Model 18.

At 506, the method 500 includes providing, to the plurality of clients, the global Neural Graphical Model. The master 104 provides the global Neural Graphical Model 20 to the clients 102. Each client 102 runs the global Neural Graphical Model 20 with the local data 14 of the client 102.

In some implementations, each client 102 personalizes the global Neural Graphical Model 20 to the data 14 of each client 102 using the algorithm to incorporate client specific features from the data 14. The data 14 of each client 102 may have different distributions and/or different feature sets. The algorithm adds units representing features specific to the data 14 of a client 102 to the global Neural Graphical Model 20 (in the input and output layers) of the client 102. Personalizing the global Neural Graphical Model 20 to the data 14 of each client 102 allows the federated learning framework to support clients 102 with overlapping feature sets in the data 14. Moreover, each client 102 can train a personalized Neural Graphical Model on the client's data 14 and analyze differences between the personalized Neural Graphical Model and the global Neural Graphical Model 20 to get valuable insight.

In some implementations, each client 102 uses the global Neural Graphical Model 20 to perform inference tasks or sampling tasks. In some implementations, each client 102 uses a personalized Neural Graphical Model to perform inference tasks or sampling tasks. The clients 102 can use either model (the global Neural Graphical Model 20 or a personalized Neural Graphical Model) depending on the task. For example, applications on the client 102 perform one or more tasks on the global Neural Graphical Model 20. Another example includes applications on the client 102 perform one or more tasks on a personalized Neural Graphical Model. One example task includes prediction using the global Neural Graphical Model 20. Another example task includes prediction using a personalized Neural Graphical Model. Another example task includes an inference task using the global Neural Graphical Model 20. Another example task includes an inference task using the global Neural Graphical Model. Inference is the process of using the global Neural Graphical Model 20 to answer queries. For example, a user provides a query to the application and the application use the global Neural Graphical Model 20 to perform the inference task on the global Neural Graphical Model 20 and output an answer to the query. The inference task may support any input data type using the global Neural Graphical Model 20. The inference task may also support any input data type using a personalized Neural Graphical Model.

The global Neural Graphical Model 20 or personalized Neural Graphical Model allows the clients 102 to query over multiple variables. Moreover, since the global Neural Graphical Model 20 learns the probability distribution of the data 14 from each client 102 over the domain, the global Neural Graphical Model 20 may be used to perform inference and sampling over any variable without needing a separate predictive model for each variable.

The method 500 allows the clients 102 to benefit from the diverse datasets from the clients 102 while keeping the data 14 private to each client's 102 environment. The global Neural Graphical Model 20 pools the data 14 from each client 102 and learns the underlying data distribution from the data 14 while keeping the data 14 within the client's 102 environment.

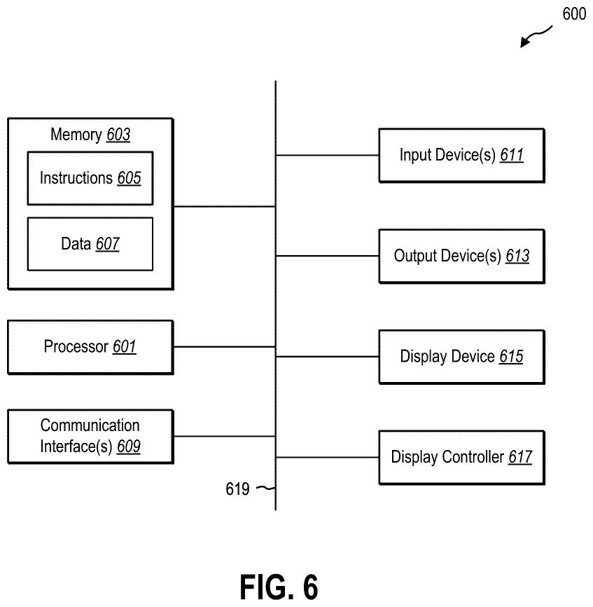

FIG. 6 illustrates components that may be included within a computer system 600. One or more computer systems 600 may be used to implement the various methods, devices, components, and/or systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth© wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

In some implementations, the various components of the computer system 600 are implemented as one device. For example, the various components of the computer system 600 are implemented in a mobile phone or tablet. Another example includes the various components of the computer system 600 implemented in a personal computer. Another example includes the various components of the computer system 600 implemented in the cloud.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving, from a plurality of clients, a plurality of feature dependency graphs, wherein each client provides a feature dependency graph created using data of each client;
generating, using a merge function, a global dependency graph from the plurality of feature dependency graphs, wherein nodes in the global dependency graph contain an intersection of features of the plurality of feature dependency graphs; and
providing, to the plurality of clients, the global dependency graph.

2. The method of claim 1, wherein the global dependency graph captures a dependency structure of input features for a domain of the data used by each client to create the plurality of feature dependency graphs without sharing the data.

3. The method of claim 2, wherein the dependency structure identifies which features in the data are directly dependent on each other and which pairs of features in the data exhibit conditional independencies given other features.

4. The method of claim 1, further comprising:
using, by each client of the plurality of clients, a graph recovery algorithm on the data of each client to generate the feature dependency graph with a dependency structure of the data.

5. The method of claim 1, wherein the merge function further includes:
identifying common features of the plurality of feature dependency graphs; and
providing a union of edges among the common features in the global dependency graph.

6. The method of claim 1, wherein the merge function maintains a size of a number of parameters of the global dependency graph of the same order of magnitude as clients' dependency graphs when combining the plurality of feature dependency graphs into the global dependency graph.

7. The method of claim 1, wherein the data is private data to the plurality of clients.

8. A method, comprising:
receiving, from a plurality of clients, a plurality of Neural Graphical Models, wherein each Neural Graphical Model is trained locally by a client using a global dependency graph and data of the client;
training a global Neural Graphical Model using the plurality of Neural Graphical Models and the global dependency graph, wherein the global Neural Graphical Model represents an aggregate distribution over a domain of the data used to train each Neural Graphical Model; and
providing, to the plurality of clients, the global Neural Graphical Model.

9. The method of claim 8, wherein the global dependency graph captures a dependency structure of input features for the domain of the data used to create the dependency structure without sharing the data.

10. The method of claim 8, wherein each client sends model parameters and a size of a dataset with a Neural Graphical Model without sharing the data used to train the Neural Graphical Model.

11. The method of claim 8, wherein training the global Neural Graphical Model further includes:
learning an average of the distribution over input features for the domain of the data in the global dependency graph.

12. The method of claim 11, wherein learning the average of the distribution over the features further includes:
adjusting the distribution to a weighted average of the plurality of Neural Graphical Models; and
adjusting a dependency structure of the global Neural Graphical Model to the dependency structure of the global dependency graph.

13. The method of claim 8, wherein training the global Neural Graphical Model further includes:
leveraging publicly available data during the training.

14. The method of claim 8, wherein each client of the plurality of clients personalizes, using an algorithm, the global Neural Graphical Model to the data of each client, wherein the algorithm adds features specific to the data of a client to the global Neural Graphical Model of the client.

15. The method of claim 8, wherein each client of the plurality of clients uses the global Neural Graphical Model to perform inference tasks or sampling tasks on the data.

16. The method of claim 8, wherein each client of the plurality of clients uses a personalized Neural Graphical Model to perform inference tasks or sampling tasks on the data.

17. A device, comprising:
a memory to store data and instructions; and
a processor operable to communicate with the memory, wherein the processor is operable to:
generate, using a merge function, a global dependency graph from a plurality of feature dependency graphs received from a plurality of clients, wherein nodes in the global dependency graph contain an intersection of features of the plurality of feature dependency graphs;
provide, to the plurality of clients, the global dependency graph;
receive, from the plurality of clients, a plurality of Neural Graphical Models trained locally by a client using data from the client and the global dependency graph;
train a global Neural Graphical Model using the plurality of Neural Graphical Models and the global dependency graph, wherein the global Neural Graphical Model represents an aggregate distribution over a domain of the data used to train each Neural Graphical Model; and
provide, to the plurality of clients, the global Neural Graphical Model.

18. The device of claim 17, wherein the global dependency graph captures a dependency structure of input features for the domain of the data used to create the dependency structure without sharing the data, and
wherein each client sends model parameters and a size of a dataset with a Neural Graphical Model without sharing the data used to train the Neural Graphical Model.

19. The device of claim 17, wherein the processor is further operable to train the global Neural Graphical Model by learning an average of the distribution over a dependency structure of input features for the domain of the data in the global dependency graph.

20. The device of claim 17, wherein each client of the plurality of clients personalizes, using an algorithm, the global Neural Graphical Model to the data of each client, wherein the algorithm adds features specific to the data of a client to the global Neural Graphical Model of the client.
